(19) United States
(12) Patent Application Publication
(10) Pub. No.: US 2026/0368167 A1
(43) Pub. Date: Nov. 19, 2026

(54) SYSTEMS AND METHODS FOR GENERATING VECTOR REPRESENTATIONS OF DATA RECORDS BASED ON SIMILARITY TO STORED RECORDS

(71) Applicant: WESCO Distribution, Inc., Pittsburgh, PA (US)

(72) Inventors: Raja Vikram Raj PANDYA, Katy, TX (US); Shashi DANDE, Spring, TX (US); Avinash WESLEY, New Caney, TX (US); Rafael DA MATTA NAVARRO, Houston, TX (US); Kishor SAITWAL, Sugar Land, TX (US); Merwan MEREBY, Baton Rouge, LA (US); Akash KHURANA, Houston, TX (US)

(73) Assignee: WESCO Distribution, Inc., Pittsburgh, PA (US)

(21) Appl. No.: 19/133,547

(22) PCT Filed: Nov. 20, 2023
(86) PCT No.: PCT/US2023/080507

§ 371 Date: May 28, 2025

Related U.S. Application Data
(60) Provisional application No. 63/428,654, filed on Nov. 29, 2022.

(51) Int. Cl. G06F 16/2453; G06F 16/22; G06F 18/2413; G06N 3/0455; G06N 3/08

(52) U.S. Cl. CPC G06F 16/24542; G06F 16/2237; G06F 18/24147; G06N 3/0455; G06N 3/08

(57) ABSTRACT

Systems, methods, and computer-readable storage media for converting data records into vector representations, then performing a query to identify stored records similar to a queried record. A system can receive a query record having multiple attributes and execute a trained siamese neural network using the query record as input, resulting in a vector representation of the query record. The system can then execute, using the vector representation, a search of a plurality of records, resulting in similar records, and present the similar records to the user.

### PRIORITY

The present disclosure claims priority to U.S. Provisional Patent Application No. 63/428,654, filed Nov. 29, 2022, the contents of which are incorporated herein in their entirety.

### BACKGROUND

### 1. Technical Field

The present disclosure relates to creating vector representations of data records, and more specifically to using neural networks/Artificial Intelligence to convert data records into vector representations using siamese networks.

### 2. Introduction

Trying to identify similar data records when there are large numbers (e.g., millions) of stored records is a computationally difficult process.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A computer-implemented method for performing the concepts disclosed herein can include: receiving, at the computer system from a user, a query record, the query record comprising a plurality of attributes; executing, via the at least one processor, the siamese neural network using the query record as input, resulting in a vector representation of the query record; executing, via the at least one processor using the vector representation, a search of a plurality of records, resulting in similar records; and providing the similar records to the user in response to the query record.

A system configured to perform the concepts disclosed herein can include: at least one processor; and a computer-readable storage medium storing instructions which, when executed by the processor, cause the at least one processor to perform a method comprising: receiving from a user a query record, the query record comprising a plurality of attributes; executing the siamese neural network using the query record as input, resulting in a vector representation of the query record; executing, using the vector representation, a search of a plurality of records, resulting in similar records; and providing the similar records to the user in response to the query record.

A non-transitory computer-readable storage medium configured as disclosed herein can have instructions stored which, when executed by a computing device, cause the computing device to perform operations which include: receiving from a user a query record, the query record comprising a plurality of attributes; executing the siamese neural network using the query record as input, resulting in a vector representation of the query record; executing, using the vector representation, a search of a plurality of records, resulting in similar records; and providing the similar records to the user in response to the query record.

### BRIEF DESCRIPTION OF THE DRAWINGS

FIG. 1 illustrates an example of a dataset of records mapping to dataset rules;

FIG. 2 illustrates an example of a siamese network;

FIG. 3 illustrates an example of using a siamese network to generate vector representations corresponding to records;

FIG. 4 illustrates an example of using Natural Language Processing (NLP) to form the vector representation;

FIG. 5 illustrates an example method embodiment; and

FIG. 6 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Businesses and organizations are required (both legally and organizationally) to store vast amounts of information about the products and services rendered. This information can then be used to identify nearly all aspects of how the products/services were produced, delivered, received, etc., and under what terms/rules (contractual or otherwise) the products/rules were rendered. For example, a distribution company may retain records about how and when a product was manufactured, from which entity it was received, and may retain additional information identifying the receiving entity to which the product was delivered and under what contract, terms, or other rules that delivery took place.

However, when there are large amounts of records corresponding to different rule sets or terms, there needs to be an efficient way of searching those records. In particular, as the matrix of records grows, the amount time (or processing cycles) required to identify similar records begins to grow exponentially. However, by converting the records into mathematical vectors, it becomes possible to treat the search as an NP-complete problem (The name “NP-complete” is short for “nondeterministic polynomial-time complete”. “Nondeterministic” refers to nondeterministic Turing machines, a way of mathematically formalizing the idea of a brute-force search algorithm.), allowing the search to be completed much faster (i.e., in polynomial time).

Systems configured as disclosed herein allow users to prepare a query record, then search large databases of records for similar records. Unlike a system which compares each attribute of the query record against each and every attribute of stored records (a very computationally expensive process), systems configured as disclosed herein can convert the query record into a vector, then score the similarity of the query record to the vectors of known/stored records. Those records which are scored most similar to the query record will share certain rules, properties, and/or attributes, and the list of most similar records can then be presented to the user or entity searching for similar records to be used as needed. This searching of identical and acceptable similar scores can be performed in a created vector space of these records.

The conversion of records to vectors can be performed using Artificial Intelligence (AI) or machine learning (ML), such as a siamese neural network. To train the siamese neural network AI algorithm used by systems the systems disclosed herein, a historical dataset of labelled similar records can be utilized-however, the amount of data required to train the siamese neural network is substantially less than a conventional Convolutional Neural Network (CNN). To generate the historical/training dataset, subject matter expert (SME) rule-based similarity methods can be used. The SME rule-based similarity methods can compare different attributes/features of records and utilize pre-assigned scores for different levels of matching between attributes of any two records. These scores can then be utilized to calculate a final weighted score representing the similarity of the two records. For example, in a particular application of B2B (business to business), these features can be related to features such as (but not limited to): 1) a product's SKU (Stock Keeping Unit), 2) customer information, 3) branch information, etc. Similarity can then be determined between these features based on SME provided rules. As an example, two different branches can be considered similar with high scores if the SME rules require them to be similar for business purpose, even if these branches are not near to each other geographically within the created vector space. The similarity between two records can be quantified in terms of similarity score (e.g., a numerical value between 0 and 1, 0 and 100, or any other appropriate range).

The resulting siamese neural network can generate a N-dimensional vector representation for the record (N being any number, and determined based on specific configuration of siamese neural network and tuning of its hyperparameters), such that there are N real numbers representing different components of vector, the N different numbers forming the vector representation for the record. One advantage of using a siamese neural network, rather than other types of neural network, is the siamese neural network configured as described herein can be trained to generate the N-dimensional vector representations for circumstances which have limited direct training examples in the historical data. Thus, implementation of a siamese neural network as disclosed herein provides a technical improvement by (1) requiring less data to train the network, and (2) providing the ability to discern between different classes or types of data using minimal data (such as classifications with a single item). The result is the ability for the siamese network to have “one-shot learning,” where a single training item can, based on the comparisons done during the siamese network training, result in classification of similar items in the future use.

The real number associated with each dimension of a N-dimensional vector is such that the vectors close to each other (closeness being measured in terms of Euclidean distance or Manhattan distance etc.) also exhibit closeness (and similarity score proportional to inverse of distance) for corresponding records which are similar as per certain rules. The siamese neural network can be trained using known similarities, with the result being that when a query record is submitted to the siamese neural network, the resulting vector representation has N-dimensions which are based on similarity to the historical examples provided in the training data for the siamese neural network.

Consider the following example. A siamese neural network has been trained using records of products sold and rules taken from contracts made with the receiving entities. When a user has a new record (a “query record”) for a product and wants to compare it to other similar records, the user can submit the query record to the trained siamese neural network and receive a vector representation of the query record. That vector representation can then be compared to stored vector representations (also previously generated by the same siamese neural network) of all other records to search similar records (target records). As this search is being performed in vector space, the system can use more efficient methods for fast searching k-nearest neighbors. In some cases, the system can create a ranked list and present the top results to the user, whereas in other cases the system can filter out any results which are not sufficiently similar (e.g., not within 75%) to the query record.

In some configurations of a siamese network, additional input records which are fed to embedding layers of the siamese neural network after input records can be represented by different methods of representing categorical variables, such as “one hot encoding” (a process by which categorical variables are converted into a different format), categorical integers, etc. These categorical representations of different tokens/words of raw records can then be input to embedding layers of siamese neural network.

In some configurations, the system can perform Natural Language Processing (NLP) on the records prior to providing input to the siamese neural network for generating vector representations, such that with the AI/ML the NLP can convert the words/sentences (and/or synonyms of the words detected through the NLP) within the record(s) into vectors. For this purpose, different algorithms such as Word2Vec, BERT (Bidirectional Encoder Representations from Transformers), etc., can be utilized.

### Example Vector Representation

Within each record are a unique set of values for different attributes/features. These attributes can describe characteristics of all records. Within some configurations these attributes can be organized and grouped into different classes (e.g., a hierarchy). Different configurations may require different value types than those provided in the below example, more or fewer value types, and more, fewer, or different classes than those shown in this example, the principles are the same.

In this example, the record stores values of attributes which are grouped into four different classes-namely: information about the product whose information is being recorded in the record (referred to as “SKU,” Stock Keeping Unit), Customer Information (e.g., who is buying or receiving the product), Geographic Information (e.g., where the product was manufactured, sold, delivered, etc.), and Rule Information (e.g., contractual rules or other terms of sale). Within each of these classes are values associated with different attributes related to the product.
(1) SKU: sku (e.g., a serial number), mfr_price_group_code (e.g., how much the manufacturer sells the product for), product_subclass (e.g., a lower/first classification of the product), product_upper_class (e.g., a higher/second classification of the product).
(2) Customer: customer_number (e.g., an identifier of a customer within a company), divisional_duns_num (e.g., a Dun & Bradstreet D-U-N-S number identifying a business entity), business_subsegment (e.g., a subsegment within a company), business_segment (e.g., a business segment within a company).
(3) Geography: branch_id (e.g., a branch identification identifying where the product was manufactured, sold, etc.), district_id (e.g., a district identification identifying where the product was manufactured, sold, etc.), region_id (e.g., a region identification identifying where the product was manufactured, sold, etc.).
(4) Rule Information: Information associated with the contract, jurisdiction, rules, or other requirements associated with the product being delivered, sold, and/or transferred.

Additional values, classes, and or other attributes/features can be included in the above list as required. Each combination of values corresponds to a unique record, with the various values being categorical variables. Using these values, the system can create a n-dimensional vector representation for each record, such that similar records are near to each other in n-dimensional space. Once appropriate vector representations for all records are created, the system can search within these vectors and identify the nearest neighbor vectors for any given vector (e.g., the query vector) of the query record. For example, the system can identify the top k records based on similarity (k being any desired number), and can present those top k records to the user for review.

Generation of Labelled Data for Similarity Score: Training of a siamese neural network requires a labelled data set of many different pairs of two records with a similarity score of the two records. The similarity score for a pair of records depends on similarity between the values of different attributes/features as fixed by subject matter experts. For example, following rule based formula can be utilized to generate similarity scores (ss):

$$ss = \frac{\begin{matrix}{W}_{S} \times ( {SKU}_{similarity} ) + {W}_{C} \times ( {Customer}_{similarity} ) + \\ {W}_{G} \times ( {Geography}_{similarity} ) + {W}_{B} \times ( Rules )\end{matrix}}{{W}_{s} + {W}_{C} + {W}_{G} + {W}_{B}}$$

Here W_{S}, W_{C}, W_{G}, W_{B} are weights representing relative importance of different similarities and have numerical values, for example, W_{S}=200, W_{C}=300, W_{G}=80, W_{B}=80 (such weights are purely exemplary). The SKU_{similarity}, Customer_{similarity}, Geography_{similarity}, Rules for a pair of records can be calculated using certain rules, such as the example rules below assigning a similarity score based on how closely grouped the records are. Please note that the following examples are examples only, are provided only for explanation purposes, and can be changed or modified to emphasize different relationships according to need. For example, in other configurations there could be more or fewer rules, different scores/numbers associated with the rules, etc. Exemplary similarity score rules:

### Sku Similarity:

Same sku=>SKU Similarity=1
Same mfr_price_group_code=>SKU Similarity=0.5
Same product_subclass=>SKU Similarity=0.3
Same product_upper_class=>SKU Similarity=0.5
Default value (i.e., no matching SKU classifications)=>SKU Similarity=0

### Customer Similarity:

Same branch_id AND Same customer_number=>Customer similarity=1
Same divisional_duns_num=>Customer similarity=0.4
Same wesco_subsegment=>Customer similarity=0.7
Same wesco_segment=>Customer similarity=0.46
Default value (i.e., no matching customer classifications)=>Customer similarity=0

### Geography Similarity:

Same branch_id=>Geography similarity=1
Same district_id=>Geography similarity=0.2
Same region_id=>Geography similarity=0.3
Default value (i.e., no matching geography classifications)=>Geography similarity=0

### Rules Related Constraints:

Verify whether the rule information exists within the table that lists all unique rule sets.
If the rule information exists, it returns a score of 1.
If the rule information does not exist, it returns a score of 0.4.
Default=0.5

The calculated similarity scores for various pairs of records are utilized in a loss function calculation during training of siamese neural network. While the examples provided above include exemplary values and weights, such values and weights can vary according to specific application/situation requiring similarities of records.

Siamese Network for Generating n-dimensional Vector Representation for Records: In this example, a siamese neural network generates vectors of records. The input to this siamese network includes values (categorical data) of various features of a record followed by an embedding layer for each feature. The weights of these embedding layers are trained by minimizing loss function which depends on predicted similarity score and actual similarity score generated for training data. The siamese neural network also contains record embedding vector layer whose output (when the network is fully trained) is an n-dimensional vector representing the input record. Once training of the network is completed, n-dimensional vector representation can be obtained for all records.

Hybrid Approach of NLP and Siamese Network: In some configurations, the obtaining of vector representation for records using a siamese network, input and embedding layer can be replaced or augmented by vector representation as generated by Natural Language Processing (NLP). In such configurations, the conversion of the record elements to vectors using NLP can be executed using methods such as (but not limited to):
word2vec: A neural network model which can learn word associations from a large corpus of text, and generates vectors for each feature's value. Can also aggregate vectors for all features for a particular record.
A transformer based approach, e.g., BERT (Bidirectional Encoder Representations for Transformers) embedding of features' values for record resulting in a vector.

In some cases, these NLP based vector representations for records may not satisfy any constraints required to maintain minimum distance between similar records. In such cases, the resulting NLP produced vectors can be further fine-tuned using a siamese neural network. In this hybrid approach, three different forms of word2vec and BERT (or similar NLP methods) can be utilized:
Available pretrained word2vec and BERT.
word2vec and BERT methods which are trained on a technical vocabulary related to the records being analyzed.
Available pretrained word2vec and BERT which are further fine-tuned by using technical vocabulary related to the records being analyzed.

With that background, consider the examples illustrated in the figures.

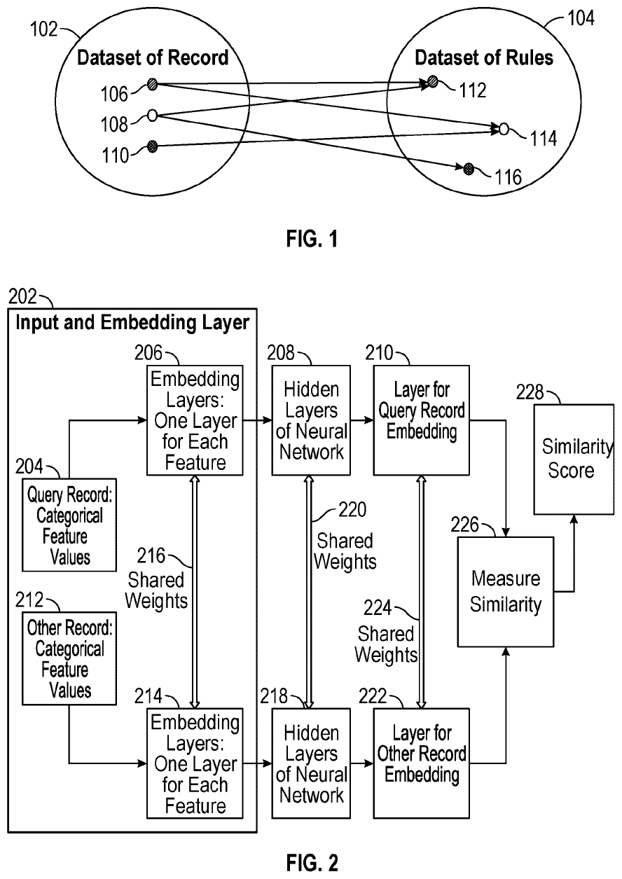

FIG. 1 illustrates an example of a dataset of a records 102 mapping to a dataset of rules 104. In this example, the dataset of records 102 has three different records 106, 108, 110, each of which are associated with one or more of the requirements 112, 114, 116 listed in the dataset of rules 104. In some cases, a particular record can be associated with multiple rules or requirements (such as record 106 complies with rules 112 and 114, and record 108 is associated with both rules 112 and 116), whereas in other cases a particular record may only be associated with a single rule (such as data 110 only complying with rule 114).

There are millions of records and rule sets available in these two datasets and many new records and rule sets are being added from time to time. The B2B situation demands an efficient way of searching the following: Knowing or given a particular record (e.g., a query record which may or may not be in the data set of records), which records (target records) are available in the data set whose rule sets also be associated with query records.

FIG. 2 illustrates an example of a siamese network. In this example, there is an input and embedding layer 202 where a query record 204 having categorical feature values is received, and the system has access to one or more other records 212 (categorical in the sense that the data falls into classes or categories of information). This pair of records are available in a dataset of records used for training the siamese neural network. The similarity scores of this pair (as calculated using above equation) are utilized for training the siamese neural network. The pair of records are fed into embedding layers 206, 214, one embedding layer 206, 214 for each feature in the query record 204 and the other record(s) 212. The system uses common weights 216 for analyzing those features and generating the embedding 206, 214.

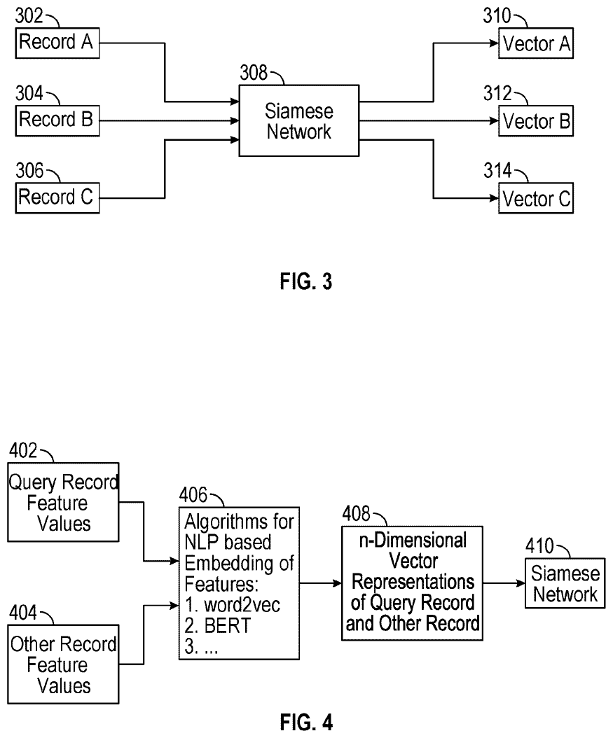

The siamese network next applies any hidden layers of the neural network 208, 218 to the output from embedding layers/vectors 206, 214. These hidden layers of the neural network 208, 218 share the same weights 220 and proceed to analyze the output of embedding layers 206, 214. The results of the hidden layers of the neural network 208, 218 are a layer for the query record embedding 210 and a similar layer 222 for the other record(s) embedding 222, again sharing weights 224. The output from a query record embedding and other records' embeddings 210, 222 are vectors of N-dimensions. The integer N represents number of neurons in layers 210 or 222. The distance between these two vectors is calculated in measuring similarity 226 and appropriately converted into a similarity score 228 (inversely proportional to distance between vectors). During training, the similarity score 228 as computed by the network is compared against a calculated similarity score for the pair, and the difference between these two scores is used for adjusting weights of the network parameters by using standard techniques of neural network. Once the network is trained, it is used to generate vector representations for all records as described by FIG. 3.

FIG. 3 illustrates an example of using a trained siamese network 308 to generate vector representations 310, 312, 314 corresponding to records 302, 304, 306. As illustrated, the siamese network 308, once trained, can receive as input data records 302, 304, 306, and the outputs from the siamese network 308 are vector representations 310, 312, 314. These vector representations are output of 210 or 222 in FIG. 2. In some configurations, the siamese network 308 can produce the vector representations 310, 312, 314 in parallel to one another, whereas in other configurations the siamese network 308 operates sequentially to produce vector representations 310, 312, 314.

FIG. 4 illustrates an example of using Natural Language Processing (NLP) to form the initial vector representation for categorical information of records, as an alternative method for 202 and its output. In this illustration, a query record 402 and one or more other records 404 input into NLP algorithm 406, such as word2vec or BERT, resulting in n-dimensional vector representations 408 of the query record 402 and the other record(s) 404 based on the words/sentences within the records 402, 404. In some configurations, the n-dimensional vector representations 408 can be ready for comparison to one another, resulting in similarity scores. However, as illustrated, the resulting n-dimensional vector representations 408 for query and other records are fed into a siamese network 410 for conversion to the final vector representations of the query record 402 and the other record(s) 404 by utilizing labelled dataset with similarity scores.

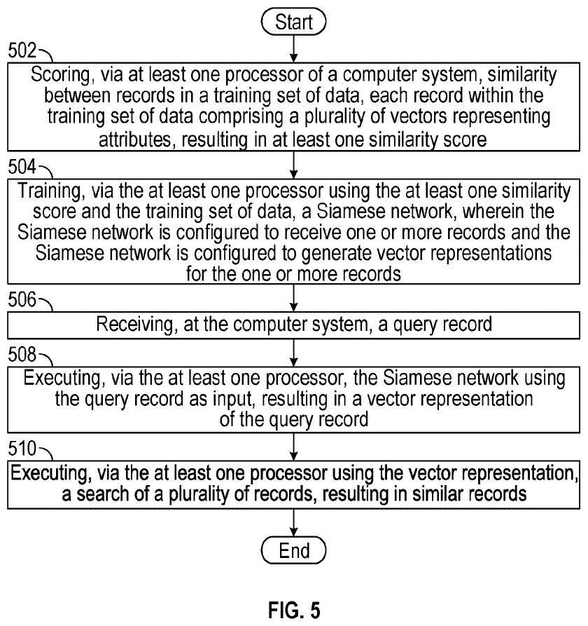

FIG. 5 illustrates an example method embodiment. The method can, for example, be implemented by a computer system. A system configured as disclosed herein can: score, via at least one processor of a computer system, similarity between records in a training set of data, each record within the training set of data comprising a plurality of vectors representing attributes, resulting in at least one similarity score (502), and train, via the at least one processor using the at least one similarity score and the training set of data, a siamese network, wherein the siamese network is configured to receive one or more records and the siamese network is configured to generate vector representations for the one or more records (504). The scoring of similarity between records (502) was described above in at least paragraphs [0027]-[0030], and the detail therein will be understood to apply equally to the method of FIG. 5. The training of the siamese network (504) was described above in at least paragraphs [0030]-[0031], and the detail therein will be understood to apply equally to the method of FIG. 5. The siamese network trained can, for example, be similar to the siamese network illustrated in FIG. 2, and the accompanying description in paragraphs [0037]-[0038]. Alternatively, the siamese network, in this example, may include a siamese neural network, or a hybrid siamese network as described in paragraph [0032], and the detail therein will be understood to apply equally to the method of FIG. 5. Moreover, in some configurations, the scoring (502) and training (504) may be done previously executed, such that the system uses an existing or trained siamese network. The system can then receive a query record (506) (e.g., from a user entering a query into the computer system via an input device. In some configurations, the user can enter each field, or attribute, where the combination of those fields forms the query record.) and execute, via the at least one processor, the siamese network using the query record as input, resulting in a vector representation of the query record (508). Execution of the siamese network (508) was described above in at least paragraphs [0031], [0039], and FIG. 3, and the detail therein will be understood to apply equally to the method of FIG. 5. The system can then execute, via the at least one processor using the vector representation, a search of a plurality of records, resulting in similar records (508). Executing a search of the plurality of records (508) was described above in at least paragraph [0027], and the detail therein will be understood to apply equally to the method of FIG. 5.

In some configurations, the plurality of records are K nearest neighbors of the query record, K being a predetermined number, and wherein the plurality of records are identified as nearest neighbors based on vector similarity. For example, the system may return the top “5” nearest neighbors based on vector similarity.

In some configurations, the scoring of the similarity performed using weights associated with each of the plurality of vectors representing attributes, values of the weights representing relative importance of each attribute.

In some configurations, the illustrated method can further include: executing, via the at least one processor prior to the execution of the search of the plurality of records, the siamese network using the plurality of records as input, resulting in a plurality of vector representations corresponding to individual records within the plurality of records, wherein the search of the plurality of records can include a comparison of the vector representation to the plurality of vector representations.

In some configurations the plurality of vectors representing attributes can be generated using Natural Language Processing. In such configurations, the Natural Language Processing can include at least one of (A) a neural network model and (B) a transformer-based machine learning algorithm.

In some configurations, the plurality of vectors representing attributes can include: a unit identification; at least one unit classification; a receiving entity; and a geographic identification.

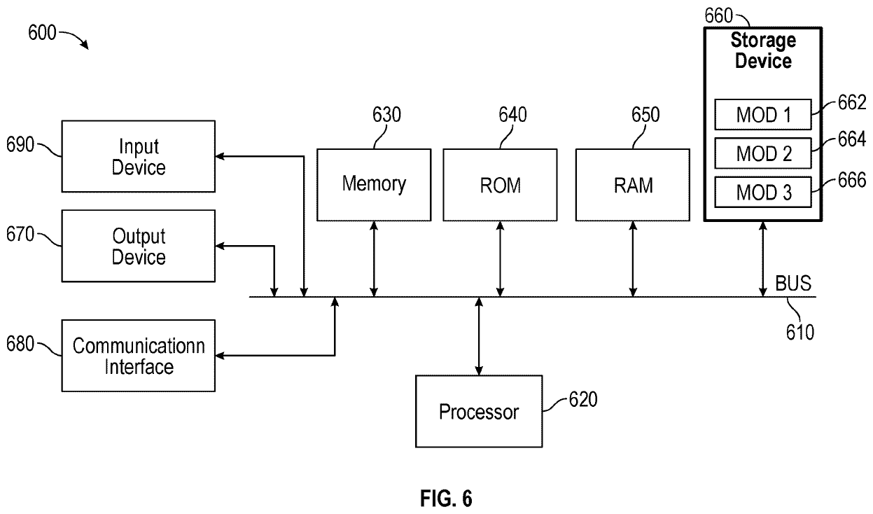

FIG. 6 illustrates an example computer system. As illustrated, an exemplary system includes a general-purpose computing device 600, including a processing unit (CPU or processor) 620 and a system bus 610 that couples various system components including the system memory 630 such as read-only memory (ROM) 640 and random-access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A computer-implemented method, comprising: scoring, via at least one processor of a computer system, similarity between records in a training set of data, each record within the training set of data comprising a plurality of vectors representing attributes, resulting in at least one similarity score; training, via the at least one processor using the at least one similarity score and the training set of data, a siamese neural network, wherein the siamese neural network is configured to receive one or more records and the siamese neural network is configured to generate vector representations for the one or more records; receiving, at the computer system a query record from the user; executing, via the at least one processor, the siamese neural network using the query record from the user as input, resulting in a vector representation of the query record from the user; executing, via the at least one processor using the vector representation, a search of a plurality of records, resulting in similar records; and providing the similar records to the user in response to the query record from the user.

A computer-implemented method comprising: receiving, at the computer system, a query record from a user, the query record comprising a plurality of attributes; executing, via the at least one processor, a trained siamese neural network using the query record from the user as input, resulting in a vector representation of the query record from the user; executing, via the at least one processor using the vector representation, a search of a plurality of records, resulting in similar records; and providing the similar records to the user in response to the query record from the user.

The computer-implemented method of any preceding clause, wherein the plurality of records are K nearest neighbors of the query record, K being a predetermined number, and wherein the plurality of records are identified as nearest neighbors based on vector similarity.

The computer-implemented method of any preceding clause, wherein the scoring of the similarity between records is performed using weights associated with each of the plurality of vectors representing attributes, values of the weights representing relative importance of each attribute.

The computer-implemented method of any preceding clause, further comprising: executing, via the at least one processor prior to the execution of the search of the plurality of records, the siamese neural network using the plurality of records as input, resulting in a plurality of vector representations corresponding to individual records within the plurality of records, wherein the search of the plurality of records comprises a comparison of the vector representation to the plurality of vector representations.

The computer-implemented method of any preceding clause, wherein the plurality of vectors representing attributes are generated using Natural Language Processing.

The computer-implemented method of any preceding clause, wherein the Natural Language Processing comprises at least one of (A) a neural network model and (B) a transformer-based machine learning algorithm.

The computer-implemented method of any preceding clause, wherein the plurality of vectors representing attributes comprise: a unit identification; at least one unit classification; a receiving entity; and a geographic identification.

The computer-implemented method of any preceding clause, further comprising: scoring, via the at least one processor of a computer system, similarity between records in a training set of data, each record within the training set of data comprising the plurality of vectors representing attributes, resulting in at least one similarity score; and training, via the at least one processor using the at least one similarity score and the training set of data, a siamese neural network, resulting in the trained siamese neural network, wherein the trained siamese neural network is configured to receive one or more records and the siamese neural network is configured to generate vector representations for the one or more records.

A system comprising: at least one processor; and a computer-readable storage medium storing instructions which, when executed by the processor, cause the at least one processor to perform a method comprising: scoring similarity between records in a training set of data, each record within the training set of data comprising a plurality of vectors representing attributes, resulting in at least one similarity score; training, using the at least one similarity score and the training set of data, a siamese neural network, wherein the siamese neural network is configured to receive one or more records and the siamese neural network is configured to generate vector representations for the one or more records; receiving a query record from a user; executing the siamese neural network using the query record from the user as input, resulting in a vector representation of the query record from the user; executing, using the vector representation, a search of a plurality of records, resulting in similar records; and providing the similar records to the user in response to the query record from the user.

A system comprising: at least one processor; and a non-transitory computer-readable storage medium storing instructions which, when executed by the processor, cause the at least one processor to perform operations comprising: receiving a query record from a user, a query record comprising a plurality of attributes; executing a trained siamese neural network using the query record from the user as input, resulting in a vector representation of the query record from the user; executing, using the vector representation, a search of a plurality of records, resulting in similar records; and providing the similar records to the user in response to the query record from the user.

The system of any preceding clause, wherein the plurality of records are K nearest neighbors of the query record, K being a predetermined number, and wherein the plurality of records are identified as nearest neighbors based on vector similarity.

The system of any preceding clause, wherein the scoring of the similarity between records is performed using weights associated with each of the plurality of vectors representing attributes, values of the weights representing relative importance of each attribute.

The system of any preceding clause, the non-transitory computer-readable storage medium having additional instructions stored which, when executed by the at least one processor, cause the at least one processor to perform operations comprising: executing, prior to the execution of the search of the plurality of records, the siamese neural network using the plurality of records as input, resulting in a plurality of vector representations corresponding to individual records within the plurality of records, wherein the search of the plurality of records comprises a comparison of the vector representation to the plurality of vector representations.

The system of any preceding clause, wherein the plurality of vectors representing attributes are generated using Natural Language Processing.

The system of any preceding clause, wherein the Natural Language Processing comprises at least one of (A) a neural network model and (B) a transformer-based machine learning algorithm.

The system of any preceding clause, wherein the plurality of vectors representing attributes comprise: a unit identification; at least one unit classification; a receiving entity; and a geographic identification.

The system of any preceding clause, the non-transitory computer-readable storage medium having additional instructions stored which, when executed by the at least one processor, cause the at least one processor to perform operations comprising: scoring similarity between records in a training set of data, each record within the training set of data comprising the plurality of vectors representing attributes, resulting in at least one similarity score; and training, using the at least one similarity score and the training set of data, a siamese neural network, resulting in the trained siamese neural network, wherein the trained siamese neural network is configured to receive one or more records and the siamese neural network is configured to generate vector representations for the one or more records.

A non-transitory computer-readable storage medium storing instructions which, when executed by at least one processor, cause the computing device to perform operations comprising: scoring similarity between records in a training set of data, each record within the training set of data comprising a plurality of vectors representing attributes, resulting in at least one similarity score; training, using the at least one similarity score and the training set of data, a siamese neural network, wherein the siamese neural network is configured to receive one or more records and the siamese neural network is configured to generate vector representations for the one or more records; receiving a query record from a user; executing the siamese neural network using the query record as input, resulting in a vector representation of the query record from the user; executing, using the vector representation, a search of a plurality of records, resulting in similar records; and providing the similar records to the user in response to the query record from the user.

A non-transitory computer-readable storage medium storing instructions which, when executed by at least one processor, cause the at least one processor to perform operations comprising: receiving a query record from a user, the query record comprising a plurality of attributes; executing a trained siamese neural network using the query record from the user as input, resulting in a vector representation of the query record from the user; executing, using the vector representation, a search of a plurality of records, resulting in similar records; and providing the similar records to the user in response to the query record from the user.

The non-transitory computer-readable storage medium of any preceding clause, wherein the plurality of records are K nearest neighbors of the query record, K being a predetermined number, and wherein the plurality of records are identified as nearest neighbors based on vector similarity.

The non-transitory computer-readable storage medium of any preceding clause, wherein the scoring of the similarity between records is performed using weights associated with each of the plurality of vectors representing attributes, values of the weights representing relative importance of each attribute.

The non-transitory computer-readable storage medium of any preceding clause, having additional instructions stored which, when executed by the at least one processor, cause the at least one processor to perform operations comprising: executing, prior to the execution of the search of the plurality of records, the siamese neural network using the plurality of records as input, resulting in a plurality of vector representations corresponding to individual records within the plurality of records, wherein the search of the plurality of records comprises a comparison of the vector representation to the plurality of vector representations.

The non-transitory computer-readable storage medium of any preceding clause, wherein the plurality of vectors representing attributes are generated using Natural Language Processing.

The non-transitory computer-readable storage medium of any preceding clause, wherein the Natural Language Processing comprises at least one of (A) a neural network model and (B) a transformer-based machine learning algorithm.

The non-transitory computer-readable storage medium of any preceding clause, wherein the plurality of vectors representing attributes comprise: a unit identification; at least one unit classification; a receiving entity; and a geographic identification.

The non-transitory computer-readable storage medium of any preceding clause having additional instructions stored which, when executed by the at least one processor, cause the at least one processor to perform operations comprising: scoring similarity between records in a training set of data, each record within the training set of data comprising the plurality of vectors representing attributes, resulting in at least one similarity score; and training, using the at least one similarity score and the training set of data, a siamese neural network, resulting in the trained siamese neural network, wherein the trained siamese neural network is configured to receive one or more records and the siamese neural network is configured to generate vector representations for the one or more records.

We claim:

1. A computer-implemented method comprising:
receiving, at the computer system, a query record from a user, the query record comprising a plurality of attributes;
executing, via the at least one processor, a trained siamese neural network using the query record from the user as input, resulting in a vector representation of the query record from the user;
executing, via the at least one processor using the vector representation, a search of a plurality of records, resulting in similar records; and
providing the similar records to the user in response to the query record from the user.

2. The computer-implemented method of claim 1, wherein the plurality of records are K nearest neighbors of the query record, K being a predetermined number, and wherein the plurality of records are identified as nearest neighbors based on vector similarity.

3. The computer-implemented method of claim 1, wherein the scoring of the similarity between records is performed using weights associated with each of the plurality of vectors representing attributes, values of the weights representing relative importance of each attribute.

4. The computer-implemented method of claim 1, further comprising:
executing, via the at least one processor prior to the execution of the search of the plurality of records, the siamese neural network using the plurality of records as input, resulting in a plurality of vector representations corresponding to individual records within the plurality of records,
wherein the search of the plurality of records comprises a comparison of the vector representation to the plurality of vector representations.

5. The computer-implemented method of claim 1, wherein the plurality of vectors representing attributes are generated using Natural Language Processing.

6. The computer-implemented method of claim 5, wherein the Natural Language Processing comprises at least one of (A) a neural network model and (B) a transformer-based machine learning algorithm.

7. The computer-implemented method of claim 1, wherein the plurality of vectors representing attributes comprise:
a unit identification;
at least one unit classification;
a receiving entity; and
a geographic identification.

8. The computer-implemented method of claim 1, further comprising:
scoring, via the at least one processor of a computer system, similarity between records in a training set of data, each record within the training set of data comprising the plurality of vectors representing attributes, resulting in at least one similarity score; and
training, via the at least one processor using the at least one similarity score and the training set of data, a siamese neural network, resulting in the trained siamese neural network, wherein the trained siamese neural network is configured to receive one or more records and the siamese neural network is configured to generate vector representations for the one or more records.

9. A system comprising:
at least one processor; and
a non-transitory computer-readable storage medium storing instructions which, when executed by the processor, cause the at least one processor to perform operations comprising:
receiving a query record from a user, a query record comprising a plurality of attributes;
executing a trained siamese neural network using the query record from the user as input, resulting in a vector representation of the query record from the user;
executing, using the vector representation, a search of a plurality of records, resulting in similar records; and
providing the similar records to the user in response to the query record from the user.

10. The system of claim 9, wherein the plurality of records are K nearest neighbors of the query record, K being a predetermined number, and wherein the plurality of records are identified as nearest neighbors based on vector similarity.

11. The system of claim 9, wherein the scoring of the similarity between records is performed using weights associated with each of the plurality of vectors representing attributes, values of the weights representing relative importance of each attribute.

12. The system of claim 9, the non-transitory computer-readable storage medium having additional instructions stored which, when executed by the at least one processor, cause the at least one processor to perform operations comprising:
executing, prior to the execution of the search of the plurality of records, the siamese neural network using the plurality of records as input, resulting in a plurality of vector representations corresponding to individual records within the plurality of records, wherein the search of the plurality of records comprises a comparison of the vector representation to the plurality of vector representations.

13. The system of claim 9, wherein the plurality of vectors representing attributes are generated using Natural Language Processing.

14. The system of claim 13, wherein the Natural Language Processing comprises at least one of (A) a neural network model and (B) a transformer-based machine learning algorithm.

15. The system of claim 9, wherein the plurality of vectors representing attributes comprise:
a unit identification;
at least one unit classification;
a receiving entity; and
a geographic identification.

16. The system of claim 9, the non-transitory computer-readable storage medium having additional instructions stored which, when executed by the at least one processor, cause the at least one processor to perform operations comprising:
scoring similarity between records in a training set of data, each record within the training set of data comprising the plurality of vectors representing attributes, resulting in at least one similarity score; and
training, using the at least one similarity score and the training set of data, a siamese neural network, resulting in the trained siamese neural network, wherein the trained siamese neural network is configured to receive one or more records and the siamese neural network is configured to generate vector representations for the one or more records.

17. A non-transitory computer-readable storage medium storing instructions which, when executed by at least one processor, cause the at least one processor to perform operations comprising:
receiving a query record from a user, the query record comprising a plurality of attributes;
executing a trained siamese neural network using the query record from the user as input, resulting in a vector representation of the query record from the user;
executing, using the vector representation, a search of a plurality of records, resulting in similar records; and
providing the similar records to the user in response to the query record from the user.

18. The non-transitory computer-readable storage medium of claim 17, wherein the plurality of records are K nearest neighbors of the query record, K being a predetermined number, and wherein the plurality of records are identified as nearest neighbors based on vector similarity.

19. The non-transitory computer-readable storage medium of claim 17, wherein the scoring of the similarity between records is performed using weights associated with each of the plurality of vectors representing attributes, values of the weights representing relative importance of each attribute.

20. The non-transitory computer-readable storage medium of claim 17, having additional instructions stored which, when executed by the at least one processor, cause the at least one processor to perform operations comprising:
executing, prior to the execution of the search of the plurality of records, the siamese neural network using the plurality of records as input, resulting in a plurality of vector representations corresponding to individual records within the plurality of records,
wherein the search of the plurality of records comprises a comparison of the vector representation to the plurality of vector representations.
